(19) United States
(12) Patent Application Publication
(10) Pub. No.: US 2010/0011840 A1
(43) Pub. Date: Jan. 21, 2010

(54) External Pipe Testing Tool and Testing Method Using Same

(75) Inventor: Glenn Carson, Sarnia (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(73) Assignee: CAR-BER Investments Inc., Point Edward (CA)

(21) Appl. No.: 12/515,655

(22) PCT Filed: Nov. 16, 2007
(86) PCT No.: PCT/CA2007/002058

§ 371 Date: May 20, 2009

Related U.S. Application Data
(60) Provisional application No. 60/866,855, filed on Nov. 21, 2006.

(51) Int. Cl. G01M 3/28

(52) U.S. Cl. 73/46; 73/49.8

(57) ABSTRACT

An apparatus for testing the integrity of pipe welds includes a sleeve for circumferentially surrounding the pipe, the sleeve having an inner diameter greater than the outer diameter of the pipe. The sleeve having end walls extending radially inwards towards the pipe wall. The apparatus including at least two seals to form a sealed annular space between the pipe, the sleeve and the sleeve end walls. A filling and pressurizing means pressurizes the annular space. The test procedure comprises monitoring of the pressure within the space.

### CROSS REFERENCE TO RELATED APPLICATIONS

This application claims priority from U.S. application Ser. No. 60/866,855, filed Nov. 21, 2006, the entire contents of which are incorporated herein by reference.

### FIELD OF THE INVENTION

The present invention relates to an apparatus and method for testing pipes and, in particular, testing the integrity of welds on pipes.

### BACKGROUND OF THE INVENTION

In chemical or petrochemical plants etc., it is often necessary to convey fluidic materials (e.g. liquids) from one location to another. The conveyance of such material normally includes equipment such as conduits or pipes, storage or reaction vessels etc., which are generally manufactured from metal. The joining of separate pieces of the conveying equipment is generally achieved by welding the necessary pieces together. For example, when joining adjacent ends of pipe together, it is common for each end to be provided with flanges, that are welded to each respective end, which are then bolted together to form a seal. Such flanges may also be provided on holding tanks and other such vessels so that such vessels can be connected to pipes or other vessels. Alternatively, the connections between lengths of pipe or other equipment may be welded directly together (i.e. butt welded) to form the seal. In either case, it will be appreciated that each welded joint or section must form a complete seal so as to prevent leakage of the materials being transported. This is particularly the case when handling potentially hazardous materials such as flammable or toxic liquids.

For reasons of safety, it is often necessary to periodically test the integrity of the welds used in joining the various pieces of equipment (such as pipes, vessels, flanges and the like) together.

The prior art provides various tools for conducting weld integrity tests on conduits. For example, U.S. Pat. Nos. 6,131,441 and 5,844,127 (the entire disclosures of which are incorporated herein by reference) teach weld testing tools that isolate a particular section of a pipe (such section including a weld) and subject the section to a high pressure fluid within a constrained annular space defined by the tool and the inner surface of the pipe. The pressure of the fluid within the annular space is monitored whereby any pressure drop signifies a leak in the weld.

The prior art devices mentioned above perform the integrity tests within the lumen of the pipe itself. However, in some circumstances, inserting a testing apparatus within the pipe to be tested is not possible. In such cases, the test must be conducted externally, that is, over the exterior surface of the pipe.

Various external test tools have been suggested in the prior art such as U.S. Pat. Nos. 4,099,405, 4,185,492, 4,184,389 and 5,616,854. However, these prior art devices are relatively complex structures that are difficult to position and/or use.

Thus, there exists a need for an external pipe testing apparatus that overcomes at least some of the deficiencies in the known approaches.

### SUMMARY OF THE INVENTION

In one aspect, the present invention provides an apparatus for testing pipes. In particular, the invention provides an apparatus that can be used for testing welds on a pipe.

In one aspect, the invention provides a non-invasive apparatus for testing the integrity of pipes wherein the testing is conducted over the external surface of the pipe.

In another aspect, the invention provides a sleeve-like apparatus that forms a sealed annular space on the external surface of a portion of a pipe, wherein the space is pressurized to detect any leakage.

Thus is one aspect, the invention provides an apparatus for testing the integrity of a pipe weld comprising:
a sleeve adapted to circumferentially surround the pipe when the apparatus is in use;
the sleeve having a body with an inner diameter greater than the pipe outer diameter;
the sleeve having opposed first and second end walls, the end walls being radially inwardly directed and located at opposed ends of the sleeve body;
first and second sealing means for sealing interfaces between the first and second end walls and the pipe outer surface, whereby, when the apparatus is in use, a sealed space is formed between the pipe outer surface, the sleeve body and the sleeve end walls; and,
a means for filling and pressurizing the sealed space.

In another aspect, the invention provides a method of testing the integrity of a pipe weld comprising:
providing a sleeve coaxial with the pipe and circumferentially overlapping the pipe, the sleeve having an inner diameter greater than the outer diameter of the pipe;
locating the sleeve over a region of the pipe including the weld;
forming a sealed annular space between the sleeve and the pipe;
filling and pressurizing the sealed annular space; and,
monitoring the pressure within the space.

### BRIEF DESCRIPTION OF THE DRAWINGS

These and other features of the invention will become more apparent in the following detailed description in which reference is made to the appended drawings wherein:

FIG. 1 is a cross sectional view of the apparatus of the invention according to one embodiment when in use with a pipe.

FIG. 2 is a perspective view of a sleeve of the apparatus according to one embodiment.

FIG. 3 is an end view of the apparatus shown in FIG. 1.

FIG. 4 is a front view of a sealing ring of the apparatus according to an embodiment.

FIG. 5 is a side view of the ring of FIG. 4.

FIG. 6 is a side view of the apparatus of the invention according to another embodiment, when in use with a pipe junction.

FIG. 7 is a side view of the apparatus of the invention according to another embodiment, when in use with a curved pipe.

FIGS. 8 to 12 are a cross sectional views of the apparatus of the invention according to other embodiments when in use with a pipe.

### DETAILED DESCRIPTION OF THE INVENTION

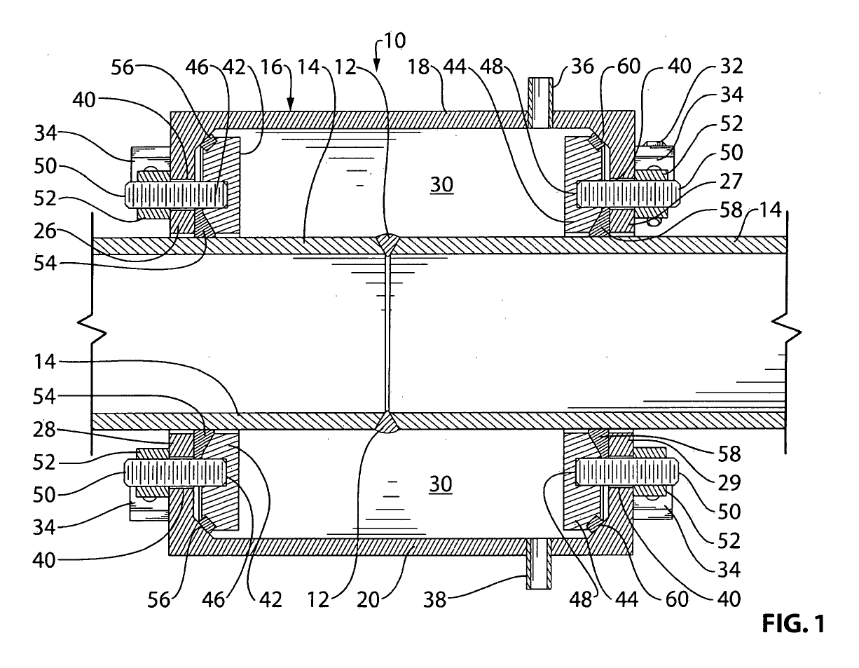

FIG. 1 illustrates one embodiment of the invention wherein an apparatus 10 according to one embodiment of the present invention is used for testing the integrity of a weld 12 on a pipe 14. As will be understood, the pipe 14 is normally cylindrical in shape having a longitudinal axis. However, the invention may be used with pipes of various shapes and sizes. Further, as described further below, the invention may be used with pipes including one or more bends. The weld 12 would be one, for example, that extends over the circumference of the pipe. Such weld would be used in situations where two pipe segments are butt-joined to form a single pipe structure. In one embodiment, the invention may be used in cases where different forms of welds are used, such those used for “T” junctions, openings etc. In general, the invention may be used to test any weld on any pipe. It will be understood that the weld 12 may take any shape or serve any other purpose. In addition, although the present invention will be described with reference to a test of weld integrity, it will be understood that the invention can also be applied to testing the integrity of pipe wall segment by itself.

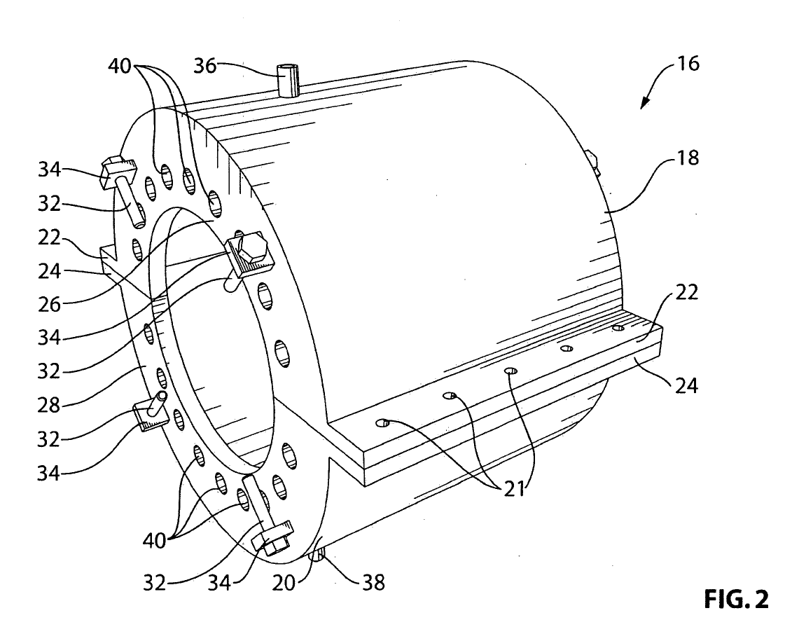

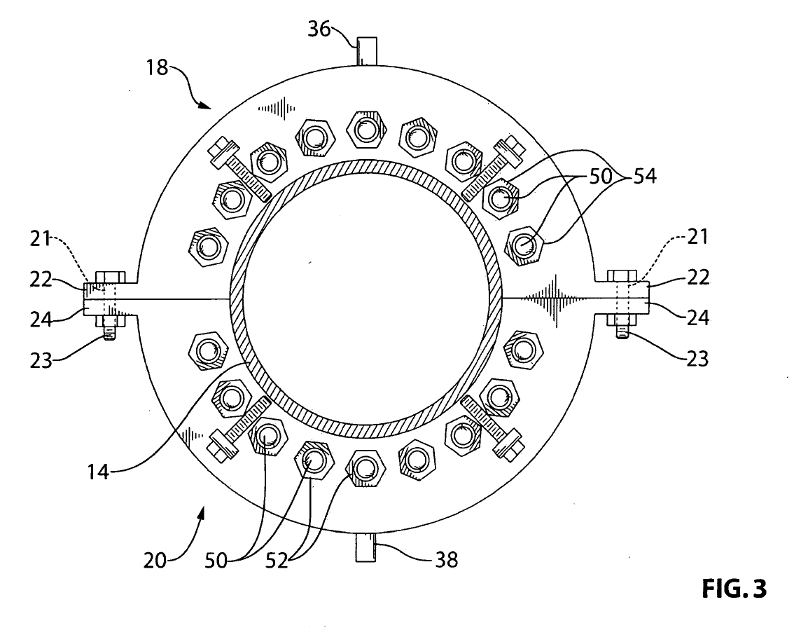

The apparatus 10 includes an outer sleeve 16 that extends circumferentially over the outer surface of the pipe 14. In the result, as shown in FIG. 1, the sleeve 16 extends generally co-axially with the pipe 14. Although FIG. 1 illustrates the sleeve 16 as preferably having a generally cylindrical shape, it will be understood that it may equally have various other shapes while still serving the purpose discussed herein. In one embodiment, the sleeve 16 is comprised of two half shells: a first half shell 18 and a second half shell 20. FIGS. 2 and 3 illustrate one example of the sleeve 16 showing the half shells 18 and 20. As illustrated, each of the half shells 18 and 20 are provided with pairs of flanges 22 and 24, respectively, wherein the flanges extend generally longitudinally substantially over the length of the sleeve 16 with one flange being provided on each end of the half shells. As shown, the flanges extend radially outward and are provided with a plurality of corresponding bolt holes 21 such that, when the shells 18 and 20 are aligned to form the sleeve 16, the respective bolt holes 21 on each of the flanges 22 and 24 are also aligned and adapted to receive bolts 23 there-through. The alignment of the bolts 23 is more clearly shown in FIG. 3. As will be understood, by providing corresponding nuts on the bolts, the two half shells 18 and 20 may be joined together to form the sleeve 16. As will be understood, a gasket or other such sealing device may be provided at the interface of the half shells 18 and 20 so as to form a seal there-between. As discussed herein, the purpose of the flanges 22 and 24 and the associated bolts 23 is to secure the two sections 18 and 20 of the sleeve 16 together. For this reason, various alternatives to such flanges may be used. For example, each flange may be replaced with a plurality of tabs. In another alternative, one flange on each of the sections 18 and 20 may be replaced with a hinge whereby the two sections are hingedly connected. In another embodiment, the sleeve 16 may comprise a unitary structure thereby avoiding the need for the flanges. It will be understood that the embodiment described above, wherein pairs of flanges are provided, or wherein the two sleeve sections are hingedly connected, would be preferred as such. sleeve would then be adaptable for use on a range of pipe diameters.

The sleeve 16 includes radially inwardly directed end walls. As illustrated in FIGS. 1 and 2, such end walls are formed by providing each end of the half shells 18 and 20 with radially inwardly projecting extensions 26, 27 and 28, 29, respectively. When the shells 18 and 20 are combined to form the sleeve 16, and when the sleeve 16 is installed over a pipe 14 as shown in FIG. 1, it is observed that a generally annular space 30 is formed between the outer surface of the pipe 14 and the inner surface of the sleeve 16. The inner surface of the sleeve 16 being bound by the inner surfaces of the half shells or sections 18 and 20 and the inner surfaces of the associated extensions 26, 27, 28 and 29.

To aid in positioning the sleeve 16, or either of the half shells 18 and 20, the sleeve and/or shells may be provided with any number of positioning bolts 32. The positioning bolts 32 extend radially inwardly and are designed to bear against the outer surface of the pipe 14 as shown in FIG. 1 (in FIG. 1, only one positioning bolt 32 is shown for convenience). The positioning bolts 32 extend through brackets 34 provided on the half shells 18 and 20 as shown in FIGS. 1 and 2. As will be understood, any number of positioning bolts 32 may be provided and such number will vary depending upon the diameter of the pipe being tested. It will also be understood that in some cases, no such positioning bolts will be needed.

One or both of the half shells 18 and 20 may be provided with One or more fluid ports extending there-through. As illustrated in FIGS. 1 and 2, each of the half shells 18 and 20 are provided with one port identified as 36 and 38. In one embodiment, one of the ports is used to fill the annular space 30 with a pressurizing fluid (as described further below) and the other port is used to vent the space 30 so as to allow air contained in the space 30 to be replaced with the fluid. Any other means of filling and pressurizing the annular space 30 may be similarly used.

As shown in FIG. 2, each of the extensions 26, 27 and 28, 29 are provided with a plurality of bolt holes 40, generally equally spaced along the circumferences of the half shells 18 and 20. The purpose of the bolt holes 40 will be explained further below.

In order to adequately seal the annular space 30, some means of sealing the end walls of the sleeve 16 to the pipe 14 surface must be provided. Provided below are various embodiments of the invention for creating such seal. Referring first to FIG. 1, the sleeve 16 is shown in the mounted position over the pipe 14 to be tested. FIG. 1 also illustrates the apparatus 10 being provided with a pair of sealing rings 42 and 44 located within the space 30 and adjacent opposite end walls of the sleeve 16. Sealing ring 42 is positioned adjacent the sleeve first end wall formed by extensions 26 and 28 while the sealing ring 44 is oppositely positioned adjacent the sleeve second end wall formed by extensions 27 and 29. The sealing rings 42 and 44 are provided with a plurality of threaded openings 46, 48, respectively, which are adapted to receive threaded portions of bolts 50, the purpose of which is described further below. In another embodiment, the bolts 50 may be permanently attached to the respective sealing rings 42, 44. In a further embodiment, as with the sleeve 16, the sealing rings 42 and 44 may be provided in two or more sections and joined together by means of a connection mechanism.

As shown in FIG. 1, the opposite ends of the bolts 50 extend through the boltholes 40 provided on the half shells 18 and 20. Cooperating nuts 52 are adapted to engage the bolts 50 thereby securing the ring 42 to extensions 26 and 28 and the ring 44 to extensions 27 and 29.

As also shown in FIG. 1, between the rings 42 and 44 and the opposing end walls of the sleeve 16, as formed by the respective extensions 26, 28 and 27, 29, are provided a number of sealing members. For example, between sealing ring 42 and the adjacent extensions 26 and 28, are provided a first set of resilient inner and outer sealing members 54 and 56, respectively. The terms “inner” and “outer” as used with respect the sealing members 54 and 56 are meant to indicate the positioning of such member with respect to the outer surface of the pipe 14. That is, the “inner” member is the member, 54, positioned closer to the pipe 14 than the “outer” member 56. As can be seen, the sealing members 54 and 56 are adapted to form a seal between adjacent surfaces of the sealing ring 42 and the extensions 26 and 28. More specifically, as the nuts 52 are tightened, the sealing ring 42 and the extensions 26 and 28 are urged towards each other thus causing deformation of the sealing members 54 and 56. In a similar manner, a second pair of resilient inner and outer sealing members 58 and 60, respectively, are provided between the sealing ring 44 and the adjacent extensions 27 and 29 and are similarly deformed as the sealing ring 44 is urged towards the extensions 27 and 29. As can be understood, tightening of the nuts 52 provided on the apparatus 10 causes radially extending seals (caused by the deformation of the sealing members 54, 56, 58 and 60) to be formed between the sealing rings 42, 44, the interior surface of the sleeve 16 and the outer surface of the pipe 14. This therefore leads to the formation of a sealed annular space 30.

Although the above described preferred embodiment includes two sealing members (i.e. the “inner” and “outer”), it will be understood that any number of such seals may be provided as deemed necessary. For example, in some situations, particularly for pipes of small diameter, only a single sealing member may be needed. As will be appreciated by persons skilled in the art, the primary seals for forming the sealed annular space 30 are the inner sealing members 54 and 58. The outer sealing members 56 and 60 provide secondary seals. As indicated above, the sealing members are generally formed of a resilient material that is capable of being deformed upon application of a physical force. Such members may comprise, for example, resilient O-rings or any other such sealing material as will be known to persons skilled in the art.

As shown in FIG. 1, surfaces of the sealing rings 42 and 44 and the extensions 26, 28, 27, 29 abutting the sealing members may be provided with a recess or bevel to receive and/or contain the sealing member. For example, as shown in FIG. 1, the surfaces of the half shells 18 and 20 abutting the outer sealing members 56 and 60 are also preferably provided with a bevelled corner. Similarly the surfaces of the sealing rings 42 and 44 abutting the outer sealing members 56 and 60 may also be preferably provided with recesses to contain the sealing members. Similarly, the surfaces of the sealing rings 42 and 44 abutting the inner sealing members 54 and 58 are provided with bevelled edges while the opposite surfaces of the extensions 26, 28, 27 and 29 are maintained flat without any bevel or recess. In other embodiments, the aforementioned bevel may be substituted with a groove etc. It will be understood that the purpose of such bevel or groove etc. is to position the sealing members. Moreover, with a bevelled surface, the deformation of the sealing members may be directed in the desired direction.

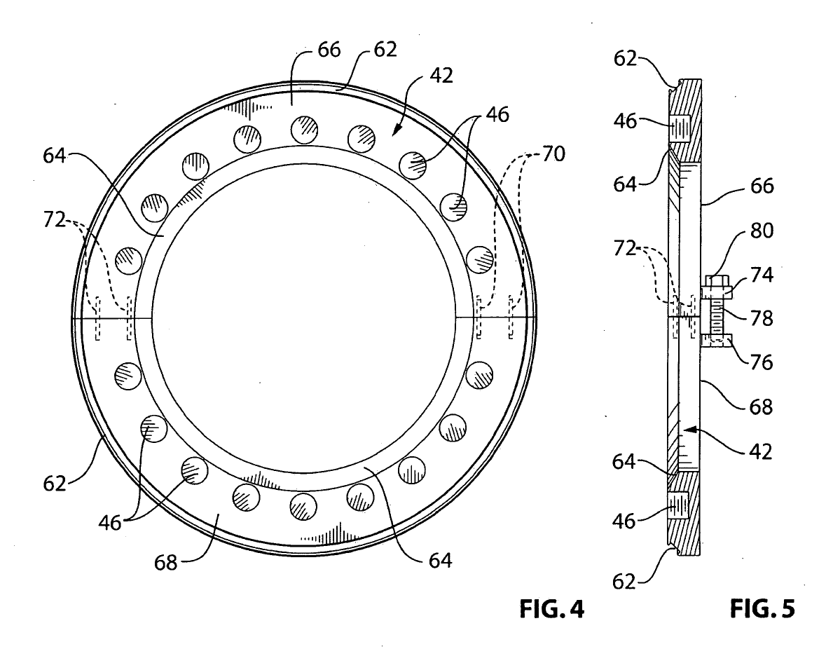

FIGS. 4 and 5 illustrate “front” and side views of the sealing ring 42. The term “front” view will be understood to mean that surface of the sealing ring 42 that abuts the end wall of the sleeve 16, that is, the extensions 26, 28. It will be understood that although the following description is provided with reference to the sealing ring 42, the description will also apply equally to the sealing ring 44. As shown, the aforementioned recess provided on the sealing ring to receive the outer sealing member is shown at 62. The bevel to receive the inner sealing member is shown at 64.

FIGS. 4 and 5 also illustrate an embodiment wherein the sealing ring 42 is provided in two sections 66 and 68. To assist in forming the ring, a number of pins 70 are provided that are received within positioning holes 72 provided on abutting sections of the sections 66 and 68. The sections may also be provided with brackets 74 and 76, respectively, which are adapted to receive one or more bolts 78. Nuts 80 can then be provided to secure the sections 66 and 68 together thereby forming the sealing ring 42. In the embodiment shown in FIG. 5, one of the brackets 74, 76 may be provided with threaded openings to receive the bolts 78. As indicated above, a similar structure can be provided for sealing ring 44. As will be understood, by providing a split sealing ring as described above, positioning of the ring over a pipe 14 would be facilitated. Further, where a large sized ring is required (that is for use on large diameter pipes), providing such rings in sections would facilitate transport and manipulation thereof.

In using the above described apparatus, the following steps would preferably be followed. Firstly the sections of the sealing rings 42 and 44 are assembled over the desired section of the pipe 14. As indicated above, this is done, for example, by means of the nuts 78 engaging one of the sections and nuts 80 securing the sections together. If needed, a sealing gasket or the like may be provided at the junction between the two sections making up each sealing ring to further enhance the sealing arrangement there-between. It will be understood that this step is followed where one or both of the sealing rings are provided in sections. Where a sealing ring comprises a unitary body, the ring may simply be slid over the pipe 14 from one end thereof. Once the two sealing rings are assembled in place, the respective inner sealing members 54 and 58 are positioned between the pipe 14 surface and the bevels (such as 64) on the sealing rings 42 and 44. The sealing members may comprise, for example, O-rings that are cut and assembled in position. The sealing members may be glued to the pipe 14 and/or the sealing rings 42, 44 to assist in maintaining them in position. After this, the outer or secondary sealing members 56, 60 are positioned in the recesses (such as 62) provided on the sealing rings 42, 44. As before, the sealing members 56, 60 may be glued in position to prevent their dislodgement prior to or during the next step. As with the sealing rings 42, 44, the resilient sealing members may also be simply slid over the pipe 14 and moved to the desired location. In such case, It will be understood that the sequence of which element (sealing member or sealing ring) is slid over the pipe would be so as to provide the arrangement shown in FIG. 1.

Once the sealing rings 42, 44 and associated inner and outer sealing members, 54, 56, 58, 60, are in position, the upper half shell 18 of the sleeve 16 is placed over the sealing rings and allowed to engage the respective portions of the inner and outer sealing members. The positioning pins 32 can be used to assist in this process. Once in position, with the bolt holes 40 of the half shell 18 aligned with the respective bolt holes 46 of the sealing rings, the bolts 50 are extended through the bolt holes 40 of the half shell and the nuts 52 are provided there-on.

After this, the lower half shell 20 is similarly placed in alignment so as to allow the bolts 50 to engage the respective bolt holes 40 and 46 of the shell 20 and the sealing ring.

Once both half shells 18 and 20 are in position over the two sealing rings 42 and 44, and the associated inner and outer sealing members, all of the nuts 52 are tightened to a desired torque so as to sufficiently deform the inner and outer sealing members to form a pressure tight seal between the apparatus 10 and the pipe 14. In the result the annular space 30 is sealed. It will be appreciated that in cases where the sleeve 16 is provided with hinged halves, both sections may be provided simultaneously.

At this point, a pressurized fluid is introduced into the sealed annular space 30 by means of at least one of the ports 36 or 38. A sufficient amount of fluid is introduced so as to fill the space 30 and void it of any air. To assist this process, the other of the ports 36 or 38 serves as a vent to vent such air. Once the space 30 is filled, the pressure therein is raised to a desired test value and such pressure is monitored. A drop in pressure would signify a leak, therefore indicating that the weld 12 is compromised. It will be appreciated that in some situations, the monitoring of the pressure is not required. That is, the annular space 30 may simply be filled, and pressurized if needed, and left in such manner by sealing the ports 36 and/or 38. Such an arrangement may be used to locally pressurize or thermally isolate a segment of the pipe.

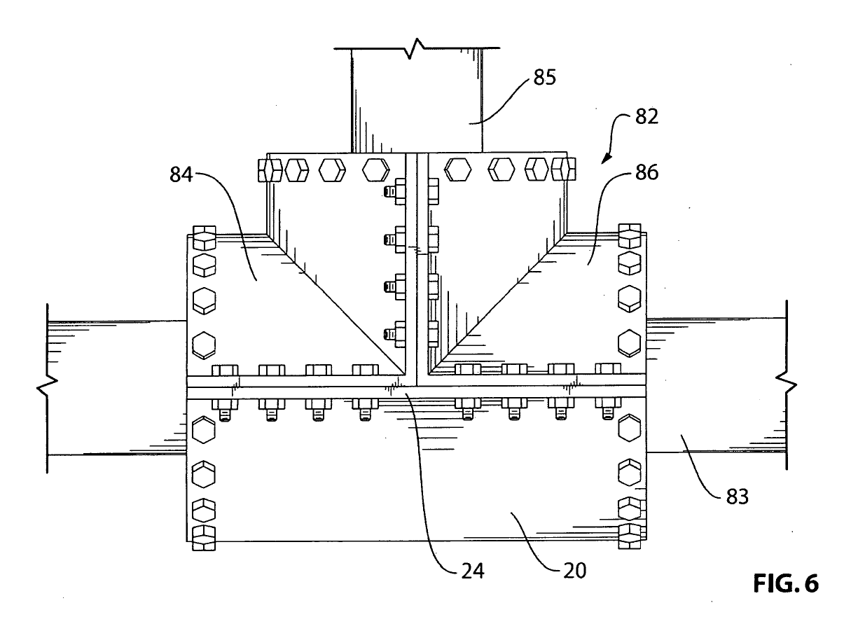

FIG. 6 illustrates another embodiment of the invention wherein the apparatus of the invention is used to test a section of a pipe junction. As shown in FIG. 6, the half shell 20 is similar to that described above. The half shell 20 includes a flange 24 and is positioned to overlap a section of a first pipe 83. However, the opposite half shell 82 is provided in two sections 84 and 86. The sections 84 and 86 are designed to accommodate a second pipe 85 provided at an angle to the first pipe 83. Typically, the junction of the two pipes is at 90°; however, it will be appreciated that any angle can be accommodated in the invention. It will be understood that two sealing rings (such as rings 42 and 44 described above) will be provided on pipe 83. Further it will be understood that a further sealing ring will be provided on the second pipe 85 to form a sealed space bounded by the shells 20, 82 and the pipes 83 and 85.

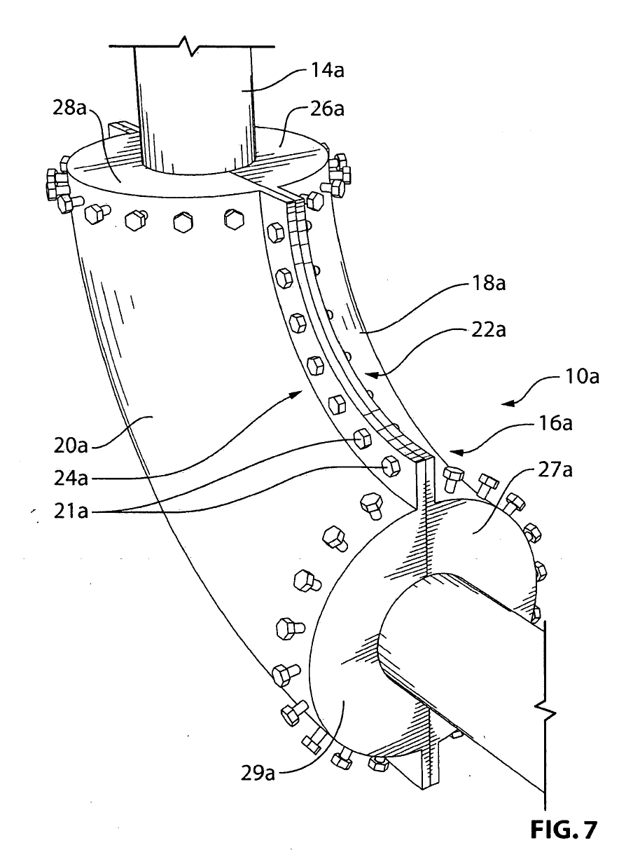

FIG. 7 illustrates a further embodiment of the invention wherein elements similar to those described above are identified with the same reference numeral but with the letter “a” added for clarity. As shown, the apparatus 10a comprises a sleeve 16a that is provided over a bend in a pipe 14a. To accommodate such curvature, the half shells 18a and 20a are similarly curved so as to adequately overlap the desired section of the pipe 14a. As will be understood, the sealing rings 42 and 44, as described above, would still be usable with the apparatus 10a since those sections where the rings are situated would preferably be linear. However, if needed, the rings may be adapted to accommodate a portion of curvature.

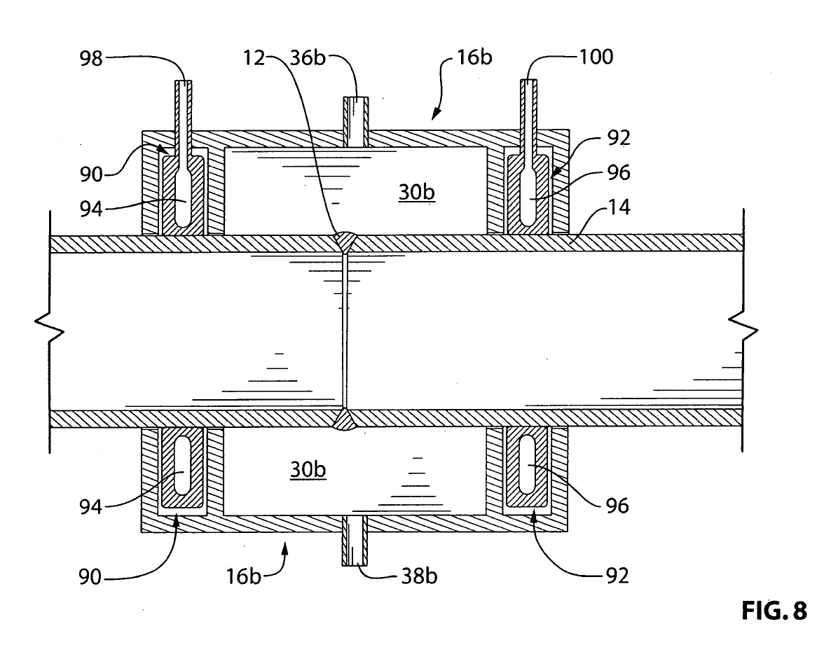

FIG. 8 illustrates a variation of the apparatus of the invention wherein elements similar to those described above are identified with the same reference numeral but, where different, with the letter “b” added for clarity. In the embodiment of FIG. 8, the sealing rings 42 and 44 are avoided. In this case, the sleeve 16b is provided with two annular cavities 90 and 92 each containing an expandable bladder 94 and 96, respectively. The cavities 90 and 92 are provided on opposite sides of a weld 12 to be tested. The bladders 94 and 96 are fluidly connected to a pressurized fluid or gas through fill lines 98 and 100, respectively. In operation, when the sleeve 16b is positioned over the weld 12 to be tested, the bladders 94 and 96 are inflated to a sufficient pressure so as to form a pressure tight seal with the outer surface of the pipe 14. At this point, a pressurized fluid is introduced into the sealed annular space 30b bounded by the bladders 94, 96, the outer wall of the pipe 14 and the sleeve 16b. The pressurized fluid is introduced through one of the ports 36b or 38b in the same manner as described above. It will be appreciated that the bladders 94 and 96 may be inflated using hydraulic or pneumatic means.

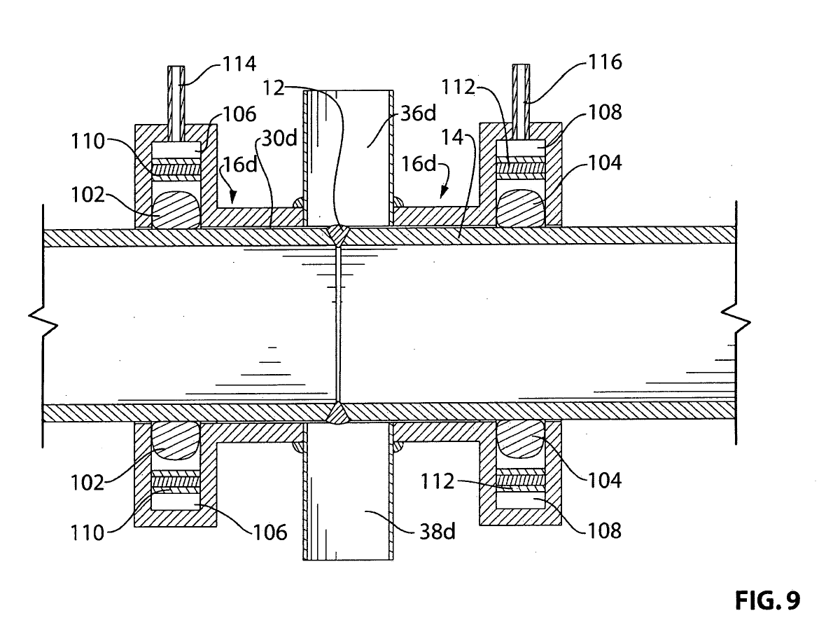

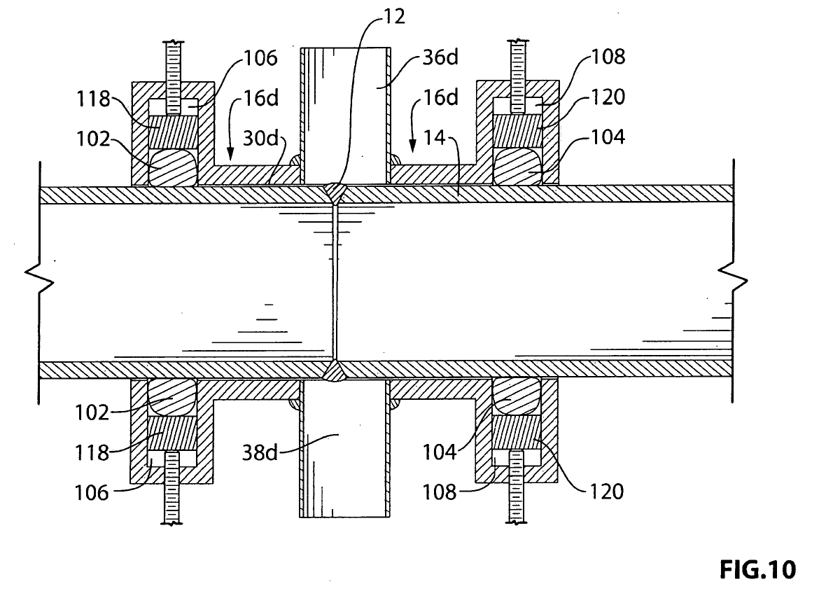

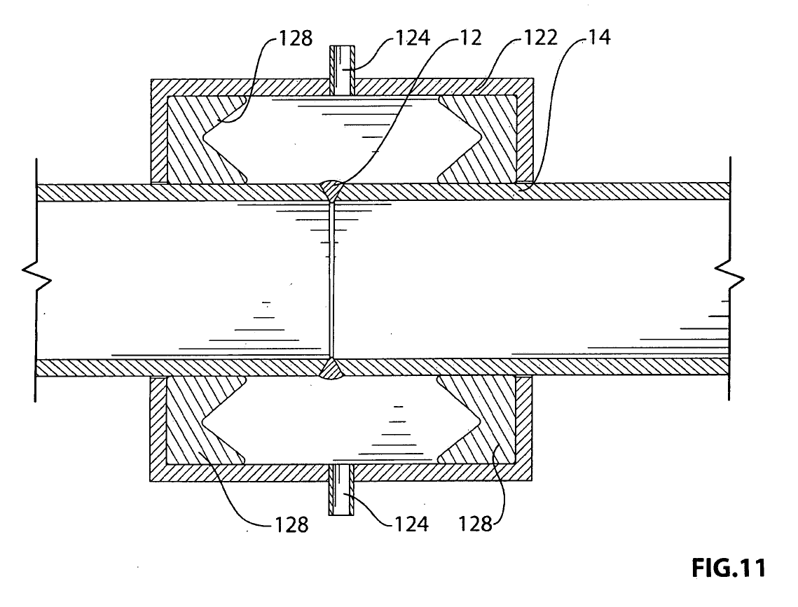

FIGS. 9 and 10 illustrate a further variation of the apparatus shown in FIG. 8. Similar elements from those mentioned above are identified with the same reference numeral but, where needed, with the letter “d” added for clarity. Specifically, instead of the bladders mentioned above, the seals shown in FIGS. 9 and 10 are provided by hydraulic (FIG. 9) or mechanical (FIG. 10) forces operating on resilient sealing members 102 and 104 provided within pockets 106 and 108 provided on opposite ends of the sleeve 16d. In FIG. 9, the seals 102 and 104 are deformed by means of a plurality of hydraulic cylinders or plungers 110 and 112 provided in the pockets 106 and 108. The cylinders or plungers 110 and 112 are driven by a pressurized fluid introduced through inlets 114 and 116, respectively, provided in the pockets 106 108. In FIG. 10, a similar force against the resilient members 102 and 104 is applied by mechanical screws 118 and 120 provided, respectively, in pockets 106 and 108.

The other feature noted in FIGS. 9 and 10 is the relatively smaller volume of the annular space 30d. This is achieved by forming the body of the sleeve 16d closer to the diameter of the pipe 14.

A further embodiment of the invention is shown in FIG. 11. In this case, the apparatus comprises a simple sleeve 122 provided over a section of a pipe 14. The sleeve includes one or more ports 124 extending into a sealed annular space 126. A resilient sealing member 128 is provided within the annular space and adjacent the opposite ends of sleeve 122. As a pressurizing fluid is introduced into the annular space 126, through at least one of the ports 124, the resilient member 128 fills any spaces between the sleeve 122 and the pipe 14 thereby forming a fluid tight seal there-between.

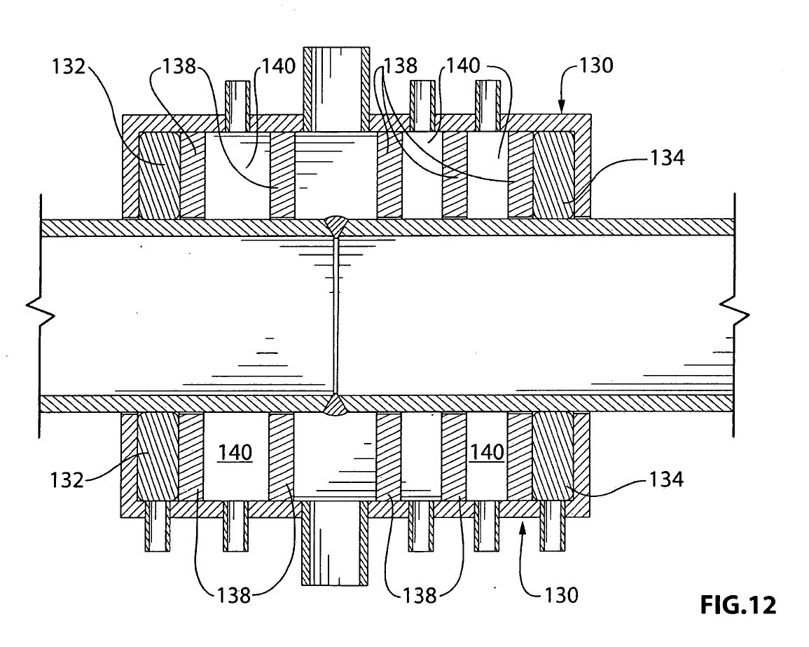

FIG. 12 illustrates a further embodiment wherein a sleeve 130 is provided over a section of a pipe 14. The sleeve 130 may include seals 132 and 134 on opposite ends thereof. The seals 132, 134 may comprise any of the seals as described above. For convenience, the various equipment needed to form the respective seals is not shown. The sleeve 130 includes one or more ports 136 to fill the space bounded by the pipe 14, the sleeve 130 and the two seals 132 and 134. In addition, the sleeve 130 shown in FIG. 12 is provided with a plurality of baffles 138 extending radially inwardly towards the pipe 14. The spaces 140 between the baffles are connected to a source of a sealant that can be sprayed towards the pipe 14, thereby further enhancing the seal between the sleeve 130 and the pipe 14.

Although the invention has been described with reference to certain specific embodiments, various modifications thereof will be apparent to those skilled in the art without departing from the purpose and scope of the invention as outlined or claimed herein. Any examples provided herein are included solely for the purpose of illustrating the invention and are not intended to limit the invention in any way. Any drawings provided herein are solely for the purpose of illustrating various aspects of the invention and are not intended to be drawn to scale or to limit the invention in any way. The disclosures of all prior art recited herein are incorporated herein by reference in their entirety.

We claim:

1. An apparatus for testing the integrity of a pipe weld comprising:
a sleeve adapted to circumferentially surround said pipe when said apparatus is in use;
the sleeve having a body with an inner diameter greater than the pipe outer diameter;
the sleeve having opposed first and second end walls, said end walls being radially inwardly directed and located at opposed ends of said sleeve body;
first and second sealing means for sealing interfaces between the first and second end walls and the pipe outer surface, whereby, when said apparatus is in use, a sealed space is formed between the pipe outer surface, the sleeve body and the sleeve end walls; and,
a means for filling and pressurizing the sealed space.

2. The apparatus of claim 1 further including a means for monitoring the pressure within said sealed space.

3. The apparatus of claim 1 wherein said sealing means comprises resilient sealing members.

4. The apparatus of claim 3 wherein said apparatus further comprises first and second sealing rings positioned against opposing faces of the sleeve end walls and wherein said resilient sealing members are provided between respective pairs of end walls and sealing rings.

5. The apparatus of claim 4 further comprising a means for urging said sealing rings towards the respective sleeve end wall.

6. The apparatus of claim 5 wherein at least one of the sealing rings or end walls includes a bevel or groove to contain a respective resilient sealing member.

7. The apparatus of claim 3 wherein said first and second sealing means comprises a pair of resilient bladders contained within respective housings provided on said sleeve.

8. The apparatus of claim 7 wherein said bladders are inflated to form seals.

9. The apparatus of claim 3 wherein said first and second sealing members are contained within respective housings provided on said sleeve.

10. The apparatus of claim 9 wherein said housings are provided with actuators for deforming said sealing members against the pipe when said apparatus is in use.

11. The apparatus of claim 10 wherein said actuators comprise hydraulic, mechanical, or pneumatic actuators.

12. The apparatus of any one of claims 1 to 11 wherein said sleeve is curved to accommodate a curved pipe.

13. The apparatus of any one of claims 1 to 12 wherein said sleeve is provided in two or more joinable sections.

14. The apparatus of any one of claims 1 to 13 wherein said sealing rings are provided in two or more joinable sections.

15. A method of testing the integrity of a pipe weld comprising:
providing a sleeve coaxial with said pipe and circumferentially overlapping said pipe, the sleeve having an inner diameter greater than the outer diameter of said pipe;
locating the sleeve over a region of the pipe including said weld;
forming a sealed annular space between the sleeve and the pipe;
filling and pressurizing the sealed annular space; and,
monitoring the pressure within said space.
